(19) United States
(12) Patent Application Publication
(10) Pub. No.: US 2022/0404733 A1
(43) Pub. Date: Dec. 22, 2022

(54) TONER TRANSFER DEVICE

(71) Applicant: Hewlett-Packard Development Company, L.P., Spring, TX (US)

(72) Inventors: Yasuyuki ISHII, Yokohama, Kanagawa (JP); Koichiro TAKASHIMA, Yokohama, Kanagawa (JP)

(73) Assignee: HEWLETT-PACKARD DEVELOPMENT COMPANY, L.P., Spring, TX (US)

(21) Appl. No.: 17/763,541

(22) PCT Filed: Sep. 16, 2020
(86) PCT No.: PCT/US2020/051029

§ 371 Date: Mar. 24, 2022

(30) Foreign Application Priority Data
Oct. 9, 2019 (JP) 2019-185969

(51) Int. Cl. G03G 15/06

(52) U.S. Cl. CPC G03G 15/065

(57) ABSTRACT

Provided is a toner transfer device including: a carrier device that includes a surface on which a charged toner is carried; an electrode that attracts the toner from the surface of the carrier device; a conveyance path of a print medium which is formed between the carrier device and the electrode; and a power supply device that causes a potential difference to occur between the carrier device and the electrode to transfer the toner from the carrier device onto the print medium when the print medium is located in the conveyance path.

### BACKGROUND ART

Among image forming systems, one performing gloss processing on an image is known. The image forming system may include a unit including a photoconductor drum for color development and a unit including a photoconductor drum for a clear toner.

### BRIEF DESCRIPTION OF DRAWINGS

FIG. 1 is a schematic view illustrating an example of an image forming system.

FIG. 2 is a schematic view illustrating an example of a gloss processing device.

FIG. 3 is a schematic view illustrating an example of a toner transfer device.

FIG. 4 is a schematic view illustrating an example of the toner transfer device.

### DESCRIPTION OF EMBODIMENTS

Hereinafter, an exemplary image forming system including a toner transfer device will be described with reference to the accompanying drawings. For example, the image forming system may be an image forming apparatus such as a printer, and may be an element that constitutes the image forming apparatus. Hereinafter, in the description based on the accompanying drawing, the same reference numeral will be given to the same element or a similar element having the same function, and redundant description thereof will be omitted.

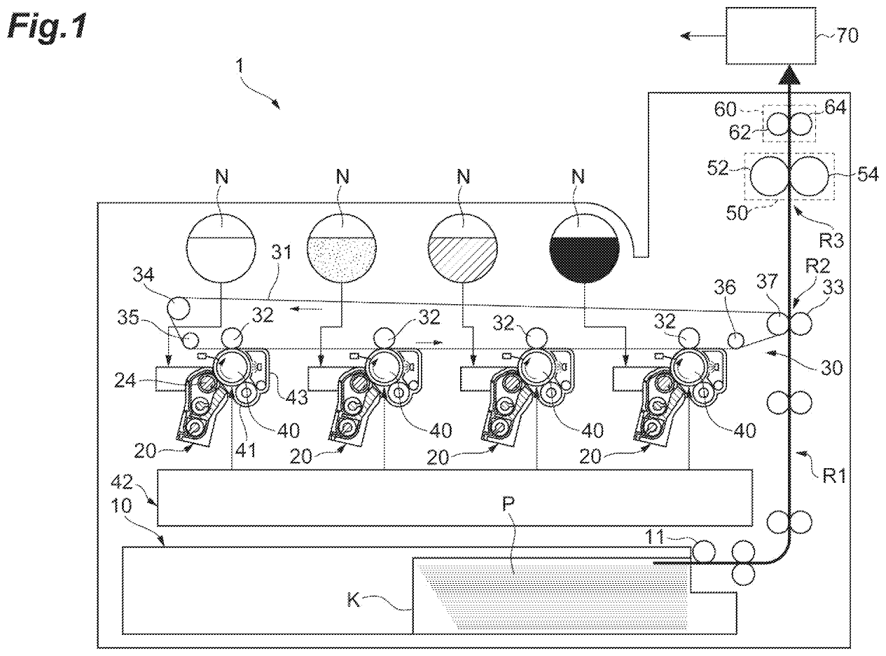

FIG. 1 is a view illustrating a schematic configuration of an exemplary image forming system. An image forming system 1 illustrated in FIG. 1 is an apparatus that forms a color image by using, for example, respective colors of magenta, yellow, cyan, and black. For example, the image forming system 1 includes a conveying device 10 that conveys paper P that is a print medium, a development device 20 that develops an electrostatic latent image with a toner, a transfer device (image transfer device) 30 that transfers the developed toner to the paper P, an image carrier 40 in which an electrostatic latent image is formed on a surface (peripheral surface), a fixing device 50 that fixes the toner to the paper P, an ejection device 60 that ejects the paper P, and a gloss processing device 70.

For example, the conveying device 10 conveys the paper P as a print medium on which an image is formed on a conveyance path R1. For example, the paper P is stacked on a cassette K and is accommodated therein, and is picked up by a paper feeding roller 11 to be conveyed. The conveying device 10 causes the paper P to reach a transfer nip portion R2 through the conveyance path R1, for example, at a timing at which a toner to be transferred to the paper P reaches the transfer nip portion R2.

For example, four pieces of the development devices 20 are respectively provided for all colors, and develops an electrostatic latent image formed on a surface of the image carrier (photoconductor) 40 to form a toner image. For example, each of the development devices 20 includes a developer carrier 24 that causes the toner (toner image) to be carried on the image carrier 40. In the development device 20, for example, as a developer, a two-component developer including a toner and a carrier is used. That is, in the development device 20, the toner and the carrier are adjusted to be a desired mixing ratio, and the toner and the carrier are mixed and stirred to uniformly disperse the toner. According to this a developer including a charged toner is adjusted. The developer is carried on the developer carrier 24. The developer carrier 24 rotates and conveys the developer to a region that faces the image carrier 40. In addition, the toner in the developer carried on the developer carrier 24 moves to the electrostatic latent image formed on the peripheral surface of the image carrier 40, and the electrostatic latent image is developed. According to this, a toner image (color toner image) is formed on the peripheral surface of the image carrier 40.

For example, the transfer device 30 conveys the toner image formed on the image carrier 40 by the development device 20 to a transfer nip portion R2 at which the toner image is secondarily transferred to the paper P. For example, the transfer device 30 includes a transfer belt 31 to which the toner image is primarily transferred from the image carrier 40, suspension rollers 34, 35, 36, and 37 which suspend the transfer belt 31, a primary transfer roller 32 that sandwiches the transfer belt 31 in combination with the image carrier 40, and a secondary transfer roller 33 that sandwiches the transfer belt 31 in combination with the suspension roller 37.

For example, the transfer belt 31 is an endless belt that is circulated by the suspension rollers 34, 35, 36, and 37. The suspension rollers 34, 35, 36, and 37 are rollers capable of rotating around respective axial lines. For example, the suspension roller 37 is a drive roller that rotates around the axial line. For example, the suspension rollers 34, 35, and 36 are driven rollers which are driven and rotated in accordance with rotation of the suspension roller 37. For example, the primary transfer roller 32 is provided to press the image carrier 40 from an inner periphery side of the transfer belt 31. For example, the secondary transfer roller 33 is disposed in parallel to the suspension roller 37 with the transfer belt 31 interposed therebetween, and is provided to press the suspension roller 37 from an outer periphery side of the transfer belt 31. According to this, the secondary transfer roller 33 forms the transfer nip portion R2 between the secondary transfer roller 33 and the transfer belt 31.

The image carrier 40 is also referred to as an electrostatic latent image carrier, a photoconductor drum, or the like. For example, each of four pieces of the image carriers 40 is provided for every color. For example, the image carriers 40 are provided along a movement direction of the transfer belt 31. For example, the development device 20, a charging roller 41, an exposure unit 42, and a cleaning device 43 are provided at the periphery of each of the image carriers 40.

For example, the charging roller 41 is a charging unit that uniformly charges a surface of the image carrier 40 to a predetermined potential. For example, the charging roller 41 moves in accordance with rotation of the image carrier 40. For example, the exposure unit 42 exposes the surface of the image carrier 40 charged by the charging roller 41 in correspondence with an image that is formed on the paper P. According to this, in the surface of the image carrier 40, a potential of a portion exposed by the exposure unit 42 varies, and thus an electrostatic latent image is formed. For example, each of the four pieces of development devices 20 develops an electrostatic latent image formed on the image carrier 40 by a toner supplied from a toner tank N provided to face the development device 20, and generates a toner image. For example, a plurality of the toner tanks N are charged with toners of magenta, yellow, cyan, and black. For example, the cleaning device 43 recovers a toner that remains on the image carrier 40 after the toner formed on the image carrier 40 is primarily transferred to the transfer belt 31.

For example, the fixing device 50 causes the paper P to pass through a fixing nip portion R3 in which the paper P is heated and pressed, thereby fixing the toner image, which is secondarily transferred from the transfer belt 31 to the paper P, to the paper P. For example, the fixing device 50 includes a heating roller 52 that heats the paper P and a pressing roller 54 that presses and rotates the heating roller 52. For example, the heating roller 52 and the pressing roller 54 are formed in a cylindrical shape, and a heat source such as a halogen lamp is provided inside the heating roller 52. The fixing nip portion R3 that is a contact region is provided between the heating roller 52 and the pressing roller 54, and the paper P is caused to pass through the fixing nip portion R3 to melt and fix the toner image to the paper P.

For example, the ejection device 60 includes ejection rollers 62 and 64 which convey the paper P to which the toner image is fixed by the fixing device 50 to the outside of the apparatus.

Next, an example of a printing process by the image forming system 1 will be described. When an image signal of an image to be recorded is input to the image forming system 1, a control unit of the image forming system 1 causes the paper feeding roller 11 to rotate so as to pick up and convey the paper P stacked in the cassette K. In addition, a surface of the image carrier 40 is uniformly charged to a predetermined potential by the charging roller 41 (charging process). Then, an electrostatic latent image is formed by irradiating the surface of the image carrier 40 with laser light by the exposure unit 42 on the basis of the image signal that is received (exposure process).

In the development device 20, the electrostatic latent image is developed and thus a toner image is formed (development process). The toner image formed in this manner is primarily transferred from the image carrier 40 to the transfer belt 31 in a region in which the image carrier 40 and the transfer belt 31 face each other (transfer process). Toner images formed on the four pieces of image carriers 40 are sequentially stacked on the transfer belt 31, and one stacked toner is formed. In addition, the stacked toner is secondarily transferred to the paper P that is conveyed from the conveying device 10 in the transfer nip portion R2 at which the suspension roller 37 and the secondary transfer roller 33 face each other.

The paper P to which the stacked toner is secondarily transferred is conveyed to the fixing device 50. In addition, when the paper P passes through the fixing nip portion R3, the fixing device 50 heats and presses the paper P between the heating roller 52 and the pressing roller 54 to melt and fix the stacked toner to the paper P (fixing process). Then, the paper P is conveyed toward the gloss processing device 70 by the ejection rollers 62 and 64.

The gloss processing device 70 subjects the paper P to which the toner image is fixed by the fixing device 50 to gloss processing. Description will be given on the assumption that the gloss processing device 70 of the example is disposed downstream of (outside) the ejection device 60 in a conveying direction, but the gloss processing device 70 may be disposed between the fixing device 50 and the ejection device 60, or may be mounted to the ejection device 60. For example, the image forming system 1 has a gloss printing mode and a normal printing mode. The gloss printing mode is a mode of feeding the paper P to which the toner is fixed by the fixing device 50 to the gloss processing device 70. The normal printing mode is a mode of ejecting the paper P to which the toner is fixed by the fixing device 50 without feeding the paper P to the gloss processing device 70. For example, the gloss printing mode and the normal printing mode can be switched from each other by setting of a user.

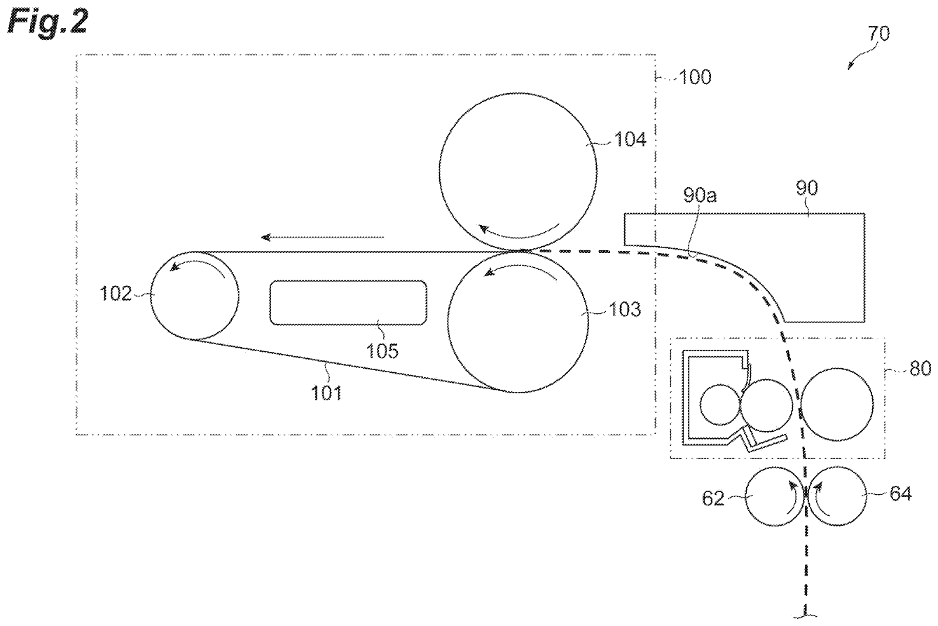

FIG. 2 is a schematic view illustrating an example of the gloss processing device. As illustrated in FIG. 2, for example, the gloss processing device 70 includes a toner transfer device 80, and a gloss application unit 100 that is disposed downstream of the toner transfer device 80 in a conveying direction. In addition, the gloss processing device 70 includes a guide member 90 that is disposed between the toner transfer device 80 and the gloss application unit 100.

The toner transfer device 80 transfers a clear toner (coating toner) to an image surface that is a surface Pa on which a toner image (CMYK image) is formed in the paper P. The toner transfer device 80 of the example transfers the clear toner to the surface Pa of the paper P from an upper side of the toner image transferred to the paper P to cover the toner image. For example, the toner transfer device 80 may transfer the clear toner to the entirety of the surface Pa of the paper P. In the example, the paper P to which the clear toner is transferred by the toner transfer device 80 is conveyed to a downstream side in the conveyance path by an operation of the ejection rollers 62 and 64.

For example, the clear toner may be a negatively charged nonmagnetic one-component toner having an average particle size of 5 μm to 10 μm. For example, an average particle size of the toner may be a volume average particle size measured by using Coulter Multisizer II type (manufactured by Beckman Coulter, Inc.). In addition, when the particle size is 5 μm or less, the average particle size may be measured using a laser diffraction scattering particle size distribution analyzer (LA-700, manufactured by HORIBA, Ltd.). In the example, an example in which a transparent clear toner is transferred to the surface Pa of the paper P is illustrated, but the toner that is transferred by the toner transfer device 80 is not limited to the clear toner. In the toner transfer device 80, a toner may be transferred to the surface Pa to coat the surface Pa of the paper P with the toner. Accordingly, the color of the toner that is transferred may be a color including silver, white, or the like, or may be a semitransparent or the like.

The guide member 90 guides the paper P that has passed through the toner transfer device 80 toward the gloss application unit 100. In the example, a conveying direction of the paper P that passes through the toner transfer device 80 is an upward side, and a direction of the paper P when being conveyed to the gloss application unit 100 is parallel to a horizontal direction. For example, the guide member 90 may include a guide surface 90a that is curved to change a direction of the paper P that is conveyed to an upward side to the horizontal direction. The guide surface 90a may be a part of an outer peripheral surface of the guide member 90. The guide surface 90a may be a curved surface that is recessed toward an inner side of the guide member 90. The paper P that is conveyed by the ejection rollers 62 and 64 passes through the toner transfer device 80, and is guided to the guide surface 90a and is conveyed to the gloss application unit 100.

The gloss application unit 100 sequentially performs a re-melting process, a cooling process, and a peeling-off process with respect to the paper P. For example, the gloss application unit 100 includes a conveying belt 101, a suspension roller 102, a heating roller 103, a pressing roller 104, and a cooling device 105.

The conveying belt 101 is an endless belt that conveys the paper P. The paper P is conveyed in a state in which the surface Pa of the paper P is in contact with a conveying surface of the conveying belt 101. The suspension roller 102 is a roller that engages with the conveying belt 101. The suspension roller 102 may be disposed downstream of the heating roller 103, the pressing roller 104, and the cooling device 105 in a conveying direction. Two or more pieces of the suspension rollers 102 may be provided. The heating roller 103 is a roller that engages with the conveying belt 101 and heats the conveying belt 101. The pressing roller 104 is a roller that is disposed on a side opposite to the heating roller 103 with respect to the conveying belt 101, and presses the conveying belt 101 against the heating roller 103. The suspension roller 102, the heating roller 103, and the pressing roller 104 may be driven rollers or drive rollers.

When the paper P passes through a nip portion between the heating roller 103 and the pressing roller 104, the paper P is heated and pressed. Toner which constitutes a toner image formed on the paper P is re-melted in a pressed state (re-melting process). At this time, the clear toner that is transferred to the paper P is also melted in a pressed state. In the re-melting process, a surface of the conveying belt 101 and the toners on the surface of the paper P may be bonded to each other. The cooling device 105 is disposed in an inner space of the conveying belt 101 and between the heating roller 103 and the suspension roller 102. The cooling device 105 cools down the conveying belt 101 and the paper P to cool down and solidifies the melted toners (cooling process). A surface shape of the conveying belt 101 is transferred to the toners on the surface of the paper P through the cooling process, and thus the toners are flattened. For example, the cooling device 105 may be a heat sink, a cooling fan, a heat pipe, a Peltier element, or the like. In the gloss application unit 100, finally, the cooled paper P is separated from the conveying belt 101 (peeling-off process), and is ejected.

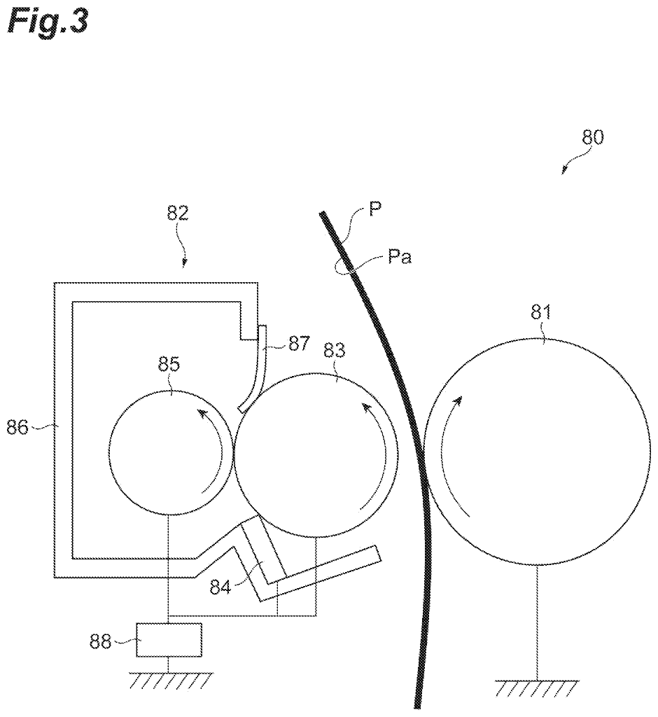

The toner transfer device 80 will be further described in detail. FIG. 3 is a schematic portion illustrating a structure of the toner transfer device 80. The toner transfer device 80 includes a toner carrier device 82 and an electrode roller (electrode) 81. The electrode roller 81 faces the toner carrier device 82 with the conveyance path of the paper P interposed therebetween. In the example, the electrode roller 81 is disposed to be separated from the toner carrier device 82. The electrode roller 81 in the illustrated example is controlled to rotate in a forward direction (direction indicated by an arrow) with respect to the conveying direction of the paper P at a first peripheral speed (surface speed) by a control device (not illustrated). In the example, the electrode roller 81 may be metal tube (for example, an aluminum pipe having a diameter of 20 mm). In addition, the electrode roller 81 may be electrically grounded.

The toner carrier device (carrier device) 82 includes a toner carrier 83, a toner regulation member 84, a toner supply member 85, a housing 86, a sealing member 87, and a power supply device 88. The clear toner is supplied onto the toner carrier 83 by the toner supply member 85. The amount of the clear toner carried on the toner carrier 83 is constantly maintained by the toner regulation member 84. According to this configuration, the clear toner is transferred to the paper P in a region (transfer region) in which the electrode roller 81 and the toner carrier 83 face each other.

The toner carrier 83 of the example may be a toner carrier roller including an outer peripheral surface (surface) on which the toner is carried. The toner carrier 83 in the illustrated example is controlled to rotate in a forward direction (direction indicated by an arrow) with respect to the conveying direction of the paper P at a second peripheral speed by a control device (not illustrated). The second peripheral speed may be the same as or different from the peripheral speed (first peripheral speed) of the electrode roller 81. In addition, the second peripheral speed may be the same as or different from the conveying speed of the paper P. In addition, a speed ratio between the peripheral speed of the toner carrier 83 and a movement speed of the paper P that is conveyed along the conveyance path may be variable.

The toner carrier 83 includes a surface layer having a conductive property. In the example, the toner carrier 83 may be a metal pipe (for example, an aluminum pipe having a diameter of 12 mm) having a surface which is formed by a conductive member, and on which a charged toner is carried. As an example, a dielectric layer that is electrically stable with respect to exposure may be formed on the surface of the metal pipe. Note that, “electrically stable with respect to exposure” represents that an electrical state is less likely to vary with respect to irradiation with light, and represents that a variation of a charged state of the dielectric layer does not occur or is less likely to occur, for example, even in a case where the dielectric layer in the charged state is exposed. The dielectric layer of the example can be formed by spray coating a phenolic resin solution in which carbon and graphite are dispersed onto a surface of a metal pipe. Surface roughness Rz of an outer peripheral surface (dielectric layer) in the toner carrier 83 may be approximately 5 μm as an example. The surface roughness Rz is an average roughness of ten points, and is a value measured based on Japanese Industrial Standards (JIS B 0601-1994).

In addition, the toner carrier 83 faces the electrode roller 81 with the conveyance path of the paper P interposed therebetween. In the example, a member (for example, a spacer rotator) that comes into contact with the surface of the electrode roller 81 and defines a distance between the electrode roller 81 and the toner carrier 83 may be provided on both ends of the toner carrier 83 in an axial direction. The size of a gap between the toner carrier 83 and the electrode roller 81 may be greater than the thickness of the paper P that is conveyed, and may be, for example, in a range of approximately 450 μm to 600 μm.

The toner supply member 85 supplies the clear toner to the toner carrier 83. In the example, the toner carrier device 82 includes the housing 86 that accommodates the clear toner, and the toner supply member 85 supplies the clear toner accommodated in the housing 86 to the toner carrier 83. The clear toner may be supplied from a supply unit (for example, a toner cartridge) (not illustrated) into the housing 86. The toner supply member 85 of the example may be a supply roller. For example, the toner supply member 85 may be a member in which urethane foam having a thickness of approximately 4.5 mm is formed on an outer periphery of a metal core having a diameter of approximately 5 mm. The toner supply member 85 is in contact with the toner carrier 83 at the inside of the housing 86, and rotates in a counter direction of the toner carrier 83. According to this, the toner supply member 85 supplies the clear toner onto the toner carrier 83, and also peels off the clear toner (residual toner) that is not transferred even after passing through a facing position of the paper P from the toner carrier 83.

As illustrated in the drawing, the toner carrier 83 is disposed outside the housing 86, and a nip portion formed by the toner supply member 85 and the toner carrier 83 is located in an opening provided in the housing 86.

The toner regulation member 84 is in contact with the toner carrier 83, forms a toner thin layer by regulating the toner on the toner carrier 83, and regulates the amount of toner and charges the toner. In the example, the amount of toner (M/A) per unit area on the toner carrier 83 may be approximately 0.5 mg/cm², and the amount of charges (Q/M) per unit mass of the toner may be approximately −40 μC/g. For example, the toner regulation member 84 may be a doctor blade obtained by coating a phosphor bronze plate having a thickness of 100 μm with a polyamide containing rubber (polyamide elastomer) having a thickness of 50 μm, that is, an insulating PA resin. The toner regulation member 84 is fixed to the housing 86 to come into contact with a downstream side of the toner carrier 83 in a rotation direction even in the nip portion formed by the toner supply member 85 and the toner carrier 83. To make the toner on a surface layer of the toner carrier 83 be a uniform thin layer, the toner regulation member 84 is in contact with the toner carrier 83 at a linear pressure of approximately 30 g/cm toward a counter direction with respect to the rotation direction of the toner carrier 83.

The sealing member 87 suppresses the clear toner inside the housing 86 from being discharged from an upper side of the toner carrier 83 to the outside. The sealing member 87 of the example is fixed to the housing 86 to cover a part of the opening in the housing 86. The sealing member 87 has flexibility, and is in contact with an outer peripheral surface of the toner carrier 83 in a curved state. The sealing member 87 seals a gap with the housing 86 formed on an upward side of the toner carrier 83.

The power supply device 88 causes a potential difference to occur between the toner carrier 83 and the electrode roller 81 in order for the clear toner to be transferred from the toner carrier 83 onto the paper P when the paper P is located in the conveyance path. The power supply device 88 supplies a bias voltage in which a DC voltage and an AC voltage are superimposed on each other to the toner carrier 83. The power supply device 88 also applies the bias voltage to the toner supply member 85 and the toner regulation member 84. The power supply device 88 of the example applies a bias voltage in which a DC voltage of −260 V is superimposed on an AC voltage having an AC amplitude of 2 kV and an AC frequency of 3 kHz to the toner carrier 83, the toner supply member 85, and the toner regulation member 84.

In the above-described toner transfer device 80, the clear toner accommodated in the housing 86 is supplied to a surface of the toner carrier 83 due to an operation of the toner supply member 85 and the toner regulation member 84. The clear toner carried on the toner carrier 83 is conveyed to a transfer region in accordance with rotation of the toner carrier 83. The clear toner in the transfer region reciprocates between the toner carrier 83 and the electrode roller 81 due to vibration (AC) electric field between the toner carrier 83 and the electrode roller 81. In this state, when the paper P enters the transfer region along a surface of the electrode roller 81, a clear toner layer is formed on a surface of the paper P. The paper P may not come into contact with the toner carrier 83. It is possible to vary the amount of the clear toner layer formed per unit area by varying a ratio of a peripheral speed of the toner carrier 83 to a movement speed of the paper P. In the example, the peripheral speed of the toner carrier 83 may be approximately 1.5 times the movement speed of the paper P. In this case, the clear toner layer can be adjusted to approximately 0.6 mg/cm².

In the above-described toner transfer device 80, the clear toner carried on the toner carrier 83 is directly transferred to the paper P, and thus a device such as a photoconductor drum is not necessary. Accordingly, the toner transfer device 80 can be manufactured at a lower cost in comparison to a development unit including the image carrier 40 that is the photoconductor drum. In addition, in the case of transferring a toner to paper by using the photoconductor drum, it is considered that the amount of toner transferred may fluctuate due to a potential variation of the photoconductor drum. In the above-described toner transfer device 80, the fluctuation of the amount of toner transferred is less likely to occur, and thus it is possible to stably transfer the toner.

In addition, the toner transfer device 80 includes the toner regulation member 84 that is adjacent to the toner carrier 83 and regulates the amount of the clear toner on the surface of the toner carrier 83. According to this, it is possible to constantly maintain the amount of the clear toner on the surface of the toner carrier 83. As a result, it is easy to adjust the amount of the clear toner that is transferred to the paper P.

In addition, the electrode roller 81 of the example is spaced apart from the toner carrier 83. According to this, it is possible to suppress the electrode roller 81 and the toner carrier 83 from coming into contact with each other, and thus it is possible to suppress the electrode roller 81 and the toner carrier 83 from being consumed.

The power supply device 88 supplies the bias voltage in which the DC voltage and the AC voltage are superimposed on each other to the toner carrier 83. According to this, the clear toner can reciprocate in a space between the toner carrier 83 and the electrode roller 81.

In addition, it is possible to vary the amount of the clear toner layer formed per unit area in the conveying direction of the paper P by varying the ratio of the peripheral speed of the toner carrier 83 to the movement speed of the paper P. For example, it is possible to form gradation in a concentration of the clear toner along the conveying direction in the case of forming the clear toner layer while varying the speed ratio.

It should be understood that all aspects, advantages, and characteristics described in this specification are not intended to be accomplished by or to be included in any one specific example and embodiment. Actually, various examples have been described and illustrated in this specification, but it should be apparent that arrangements and details can be corrected in other examples. We claim all variations and modifications included in the spirit and scope of the protection subject matter claimed herein.

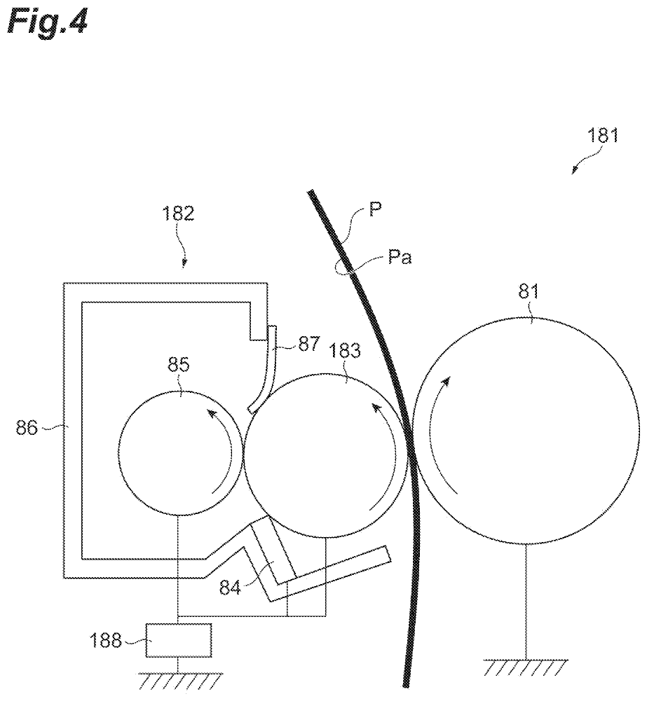

In the above-described toner transfer device 80, an example in which the toner carrier 83 and the electrode roller 81 are spaced apart from each other has been illustrated, but the toner carrier and the electrode roller may be in contact with each other as illustrated in FIG. 4. FIG. 4 is a schematic portion illustrating a structure of a toner transfer device 180. The toner transfer device 180 includes a toner carrier device 182 and an electrode roller 81. The toner carrier device 182 includes a toner carrier 183, a toner regulation member 84, a toner supply member 85, a housing 86, a sealing member 87, and a power supply device 188.

The toner carrier 183 illustrated in FIG. 4 may be a toner carrier roller including an outer peripheral surface (surface) on which the toner is carried. The toner carrier 183 is controlled to rotate in a forward direction (direction indicated by an arrow) with respect to the conveying direction of the paper P by a control device (not illustrated). A peripheral speed of the toner carrier 183 and a peripheral speed of the electrode roller 81 are set to be the same as each other. In addition, the peripheral speed of the toner carrier 183 and the peripheral speed of the electrode roller 81 may be the same as the conveying speed of the paper P.

In the example, the toner carrier 183 may be a metal pipe (for example, an aluminum pipe having a diameter of 12 mm) having a surface which is formed by a conductive member, and on which a charged toner is carried. As an example, a dielectric layer that is electrically stable with respect to exposure may be formed on the surface of the metal pipe. For example, the dielectric layer can be formed by spray coating a phenolic resin solution in which carbon and graphite are dispersed. Surface roughness Rz in the toner carrier 183 may be approximately 10 μm to 50 μm as an example. In addition, the dielectric layer that is the outer peripheral surface (surface) of the toner carrier 183 may have electric resistance of 10⁸Ω or more.

In addition, the toner carrier 183 faces the electrode roller 81 with the conveyance path of the paper P interposed therebetween. In the example, the toner carrier 183 and the electrode roller 81 are in contact with each other in a facing region (transfer region). The conveyance path of the paper P overlaps the transfer region. When the paper P is located in the conveyance path, the toner carrier 183 and the electrode roller 81 are disposed to be adjacent to each other so that the paper P comes into contact with both the toner carrier 183 and the electrode roller 81. That is, in the electrode roller 81, a surface portion that is offset from the conveyance path may be in contact with the toner carrier 183. The toner carrier 183 and the electrode roller 81 are drive rollers, and an operation thereof is controlled by a control device (not illustrated).

The power supply device 188 causes a potential difference to occur between the toner carrier 183 and the electrode roller 81 in order for the clear toner to be transferred from the toner carrier 183 onto the surface Pa of the paper P when the paper P is located in the conveyance path. The power supply device 188 supplies a DC voltage to the toner carrier 183 as a bias voltage. The power supply device 188 also applies the bias voltage to the toner supply member 85 and the toner regulation member 84. The power supply device 188 of the example can apply any DC voltage in a range of −3000 V to 1000 V to the toner carrier 183, the toner supply member 85, and the toner regulation member 84.

In the above-described toner transfer device 180, the clear toner accommodated in the housing 86 is supplied to a surface of the toner carrier 183 due to an operation of the toner supply member 85 and the toner regulation member 84. The clear toner carried on the toner carrier 183 is conveyed to a transfer region (nip region) in accordance with rotation of the toner carrier 183. In this state, when the paper P enters the transfer region along a surface of the electrode roller 81, the clear toner in the transfer region is transferred from the toner carrier 183 to the surface Pa of the paper P due to an operation of an electric field between the toner carrier 183 and the electrode roller 81.

In the example illustrated in FIG. 4, the clear toner carried on the toner carrier 183 is directly transferred to the paper P, and thus it is possible to uniformly transfer the clear toner to the paper P in a stable state.

In addition, the toner carrier 183 and the electrode roller 81 are drive rollers. According to this, the paper P sandwiched by the toner carrier 183 and the electrode roller 81 is conveyed by operations of both the toner carrier 183 and the electrode roller 81. In this case, it is possible to stably convey the paper P along the conveyance path. Particularly, in a case where the peripheral speed of the toner carrier 183 and the peripheral speed of the electrode roller 81 are the same as each other, it is possible to convey the paper P without changing the conveying direction.

In addition, the surface of the toner carrier 183 is formed from an insulating material having electric resistance of 10⁸Ω or more. In this case, even when the toner carrier 183 and the electrode roller 81 are in contact with each other, a current is less likely to flow from the toner carrier 183 to the electrode roller 81, and thus the toner carrier 183 and the electrode roller 81 are suppressed from being an equipotential.

In addition, an average particle size of the clear toner is 5 μm to 10 μm, and the surface roughness Rz of the surface of the toner carrier 183 is 10 μm to 50 μm. According to this, it is possible to carry a sufficient amount of clear toner on the surface of the toner carrier 183. Even when the peripheral speed of the toner carrier 183 and the conveying speed of the paper P are the same as each other, it is possible to transfer a stable amount of clear toner to the paper P.

In the example illustrated in FIG. 4, the toner transfer device 180 may not be disposed downstream of the ejection rollers 62 and 64. For example, the toner transfer device 180 may be disposed between the transfer device 30 and the fixing device 50. In this case, the toner transfer device 180 transfers the clear toner to the entirety of a surface of the paper P from an upper side of CMYK images transferred to the paper P before fixing. In the arrangement, the configuration of the fixing device 50 can be set to be similar to the configuration of the gloss application unit 100.

In addition, in the toner transfer device of the example, the one-component toner is transferred from the toner carrier to the paper, but the toner transferred by the toner transfer device may be a two-component toner including a carrier. In this case, the toner carrier of the toner transfer device carries the two-component toner and transfers only the toner in the carried two-component toner to paper.

1. A toner transfer device comprising:
a carrier device that includes a surface which is formed by a conductive member and on which a charged toner is carried;
an electrode that attracts the toner from the surface of the carrier device;
a conveyance path of a print medium which is formed between the carrier device and the electrode; and
a power supply device that causes a potential difference to occur between the carrier device and the electrode to transfer the toner from the carrier device onto the print medium when the print medium is located in the conveyance path.

2. The toner transfer device according to claim 1, further comprising:
a toner regulation member that is adjacent to the carrier device and regulates the amount of the toner on the surface of the carrier device.

3. The toner transfer device according to claim 1,
wherein the electrode is spaced apart from the carrier device.

4. The toner transfer device according to claim 3,
wherein the power supply device supplies a DC voltage and an AC voltage in a state of being superimposed on each other to the carrier device.

5. The toner transfer device according to claim 3,
wherein the carrier device includes a carrier roller that includes the surface on which the toner is carried.

6. The toner transfer device according to claim 5,
wherein a speed ratio between a peripheral speed of the carrier roller and a movement speed of the print medium that is conveyed along the conveyance path is variable.

7. The toner transfer device according to claim 1,
wherein the electrode is disposed to be adjacent to the carrier device so that the print medium comes into contact with both the carrier device and the electrode when the print medium is located in the conveyance path.

8. The toner transfer device according to claim 7,
wherein the carrier device includes a carrier roller and the electrode includes an electrode roller, and
the carrier roller and the electrode roller are drive rollers.

9. The toner transfer device according to claim 8,
wherein a peripheral speed of the carrier roller and a peripheral speed of the electrode roller are the same as each other.

10. The toner transfer device according to claim 7,
wherein the power supply device supplies a DC voltage to the carrier device.

11. The toner transfer device according to claim 7,
wherein the surface of the carrier device is formed from an insulating material having electric resistance of 10⁸Ω or more.

12. The toner transfer device according to claim 7,
wherein an average particle size of the toner is 5 μm to 10 μm, and
surface roughness Rz of the surface of the carrier device is 10 μm to 50 μm.

13. An image forming system comprising:
a photoconductor including a surface on which an electrostatic latent image is formed;
a development device that develops the electrostatic latent image formed on the surface of the photoconductor to form a toner image;
an image transfer device that transfers the toner image to a print medium; and
a toner transfer device including a carrier that includes a surface which is formed by a conductive member and on which a charged coating toner is carried, an electrode that attracts the coating toner from the carrier, a conveyance path of the print medium which is formed between the carrier and the electrode, and a power supply device that causes a potential difference to occur between the carrier and the electrode to transfer the coating toner from the carrier onto the print medium from an upper side of the toner image when the print medium is located in the conveyance path.

14. The image forming system according to claim 13, further comprising:
a fixing device that fixes the toner image formed on the print medium,
wherein the fixing device is located between the image transfer device and the toner transfer device.

15. The image forming system according to claim 13, further comprising:
a fixing device that fixes the toner image and the coating toner which are formed on the print medium,
wherein the toner transfer device is located between the image transfer device and the fixing device.
